(19) United States
(12) Patent Application Publication
(10) Pub. No.: US 2011/0221636 A1
(43) Pub. Date: Sep. 15, 2011

(54) Multiband Antenna

(75) Inventors: Tsung-Wen Chiu, Taipei (TW); Fu Ren Hsiao, Taipei (TW); Po-Yuan Liao, Taipei (TW)

(73) Assignee: ADVANCED CONNECTEK, INC., Taipei County (TW)

(21) Appl. No.: 12/825,080

(22) Filed: Jun. 28, 2010

(30) Foreign Application Priority Data
Mar. 12, 2010 (TW) 099107222

(51) Int. Cl. H01Q 5/00; H01Q 9/04

(52) U.S. Cl. 343/700 MS

(57) ABSTRACT

A multiband antenna comprises a feeder member, a radiation conductor, a short-circuit member, a grounding plane and a feeder cable. The feeder member has a first coupling side. Two end of the short-circuit member are respectively connected with the radiation conductor and the grounding plane. The short-circuit member has a second coupling side parallel to and conformable to the first coupling side with a gap existing therebetween. The feeder cable has a central wire and an outer wire respectively connected with the feeder member and the grounding plane. The feeder member transmits a high-frequency fed-in signal to the short-circuit member in a capacitive coupling way. The multiband antenna of the present invention has a simplified antenna structure, a miniaturized size and wide frequency bands.

### BACKGROUND OF THE INVENTION

1. Field of the Invention

The present invention relates to a multiband antenna, particularly to a radiation conductor structure, wherein the high-frequency fed-in signal is directly coupled to the short-circuit member.

2. Description of the Related Art

Wireless communication products have been extensively popularized, and the related components are also growing more and more sophisticated. Particularly, the size and transmission performance of the antenna usually influence the sales volume of the product. How to integrate the transmission functions of multiple frequency bands into a limited accommodation space has become a critical technology for the manufacturers and researchers.

The conventional multiband antenna usually integrates at least two different antennae. A U.S. Pat. No. 6,204,819 disclosed a “Convertible Loop/Inverted-F Antennas and Wireless Communicators Incorporating the Same”, which is a dual-band antenna integrating an inverted-F antenna and a loop antenna, wherein a selecting switch feeds different signals into the two different antennae. However, the conventional dual-band antenna is a 3D structure bulky and hard to layout. Further, it needs a switching chip to operate band switching. Therefore, it has a complicated circuit structure and a higher the fabrication cost.

Another conventional technology use an antenna structure having complicated shapes and diversified dimensions to achieve a multiband function. However, the designers are usually beset by the complicated shapes and dimensions of this type of antennae because they are hard to layout in a wireless communication product.

### SUMMARY OF THE INVENTION

One objective of the present invention is to provide a multiband antenna, which uses a feeder member to directly transmit a high-frequency fed-in signal to a short-circuit member to excite a high-frequency resonant mode, and which uses a radiation conductor to excite a low-frequency resonant mode, whereby are integrated the standard frequency bands of the high-frequency and low-frequency system, and whereby the multiband antenna has superior transmission frequency bands and a miniaturized size.

Another objective of the present invention is to provide a multiband antenna, which uses a feeder member to transmit a high-frequency fed-in signal to a short-circuit member via capacitive coupling, wherein a coupling unit that is formed of two coupling sides generates a capacitive reactance that makes the high-frequency and low-frequency systems of the antenna have superior impedance matching, and wherein the serpentine design of the short-circuit member can effectively shorten the extension path of the radiation conductor and modify the inductance to adjust the impedance matching of the antenna, whereby the antenna has a great transmission frequency bandwidth and a reliable transmission quality.

To achieve the abovementioned objectives, the present invention proposes a multiband antenna, which comprises a feeder member, a radiation conductor, a short-circuit member, a grounding plane and a feeder cable. The feeder member has a first coupling side. One end of the short-circuit member is connected with the radiation conductor. The short-circuit member has a second coupling side extending along and conformable to the first coupling side with a gap existing therebetween. Another end of the short-circuit member is connected with the grounding plane. The feeder cable includes a central wire and an outer wire. The central wire is connected with the feeder member, and the outer wire is connected with the grounding plane.

The present invention uses the first coupling side of the feeder member and the second coupling side of the short-circuit member to form a transmission path of a high-frequency fed-in signal. The present invention obtains the standard frequency bands of the high-frequency and low-frequency systems via the transmission path. As to the standard frequency band of the low-frequency system, the radiation conductor is used to excite the low-frequency resonant mode of the antenna system. When the coupling unit formed of the two coupling sides couples the high-frequency signal of the feeder cable from the feeder member to the short-circuit member, the standard frequency band of the low-frequency system is generated. The short-circuit member has a serpentine path. The inductance can be adjusted via modifying the gap, width and total length of the serpentine path. Thus is modulated the impedance matching of the antenna. Further, the capacitive reactance generated by the coupling unit can implement the antenna to have superior impedance matching. Thereby, the antenna system has a great transmission frequency bandwidth and a reliable transmission quality.

As to the standard frequency band of the high-frequency system, the feeder member receives a high-frequency fed-in signal to excite a high-frequency resonant mode and generate the standard frequency band of the high-frequency system. Similarly via modifying the gap, width and total length of the serpentine path can be adjusted the inductance to make the antenna system have superior impedance matching.

Below, the embodiments are described in detail to make easily understood the technical contents of the present invention.

### BRIEF DESCRIPTION OF THE DRAWINGS

FIG. 1 is a top view of a multiband antenna according to a first embodiment of the present invention;

FIG. 2 is a top view of a multiband antenna according a second embodiment of the present invention;

FIG. 3 is a top view of a multiband antenna according a third embodiment of the present invention;

FIG. 4 is a diagram showing the measurement results of the return loss of the multiband antenna of the third embodiment; and

FIG. 5 is a partially-enlarged view schematically showing that the multiband antenna of the third embodiment is integrated with a portable computer.

### DETAILED DESCRIPTION OF THE INVENTION

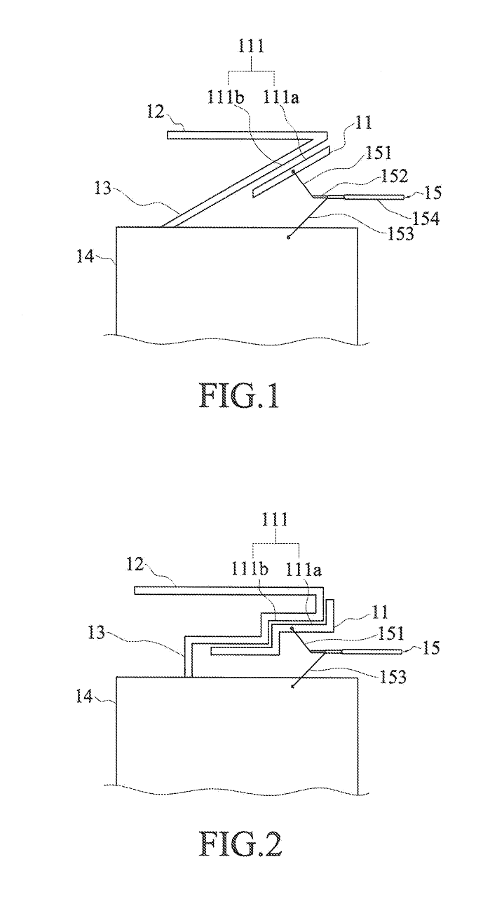

Refer to FIG. 1 a top view of a multiband antenna according to a first embodiment of the present invention. The multiband antenna of the present invention comprises a feeder member 11, a radiation conductor 12, a short-circuit member 13, a grounding plane 14 and a feeder cable 15.

The feeder cable 15 has a central wire 151, an insulating layer 152, an outer wire 153 and a coating layer 154 from inside to outside.

The feeder member 11 has a first coupling side 111a. The lateral side of the radiation conductor 12 is parallel to the side of the grounding plane 14. One end of the short-circuit member 13 is connected with the radiation conductor 12. The short-circuit member 12 has a second coupling side 111b parallel to the first coupling side 111a and conformable to the shape of the first coupling side 111a with a gap existing therebetween. The first coupling side 111a of the feeder member 11 and the second coupling side 111b of the short-circuit member 13 form a coupling unit 111 that generates a capacitive coupling transmission effect. Another end of the short-circuit member 13 is connected with the grounding plane 14. In this embodiment, the short-circuit member 13 is designed to have a straight-line shape. The central wire 151 of the feeder cable 15 is connected with the feeder member 11, and the outer wire 153 is connected with the grounding plane 14.

In operation, the high-frequency signal is fed into the antenna system via the feeder cable 15 to excite a low-frequency resonant mode of the antenna system. The central wire 151 transmits the signal to the feeder member 11. The first coupling side 111a of the feeder member 11 couples the signal to the second coupling side 111b of the short-circuit 13. Then, the signal is transmitted to the grounding plane 14 via one end of the short-circuit member 13. The signal is also transmitted to the radiation conductor 12 via another end of the short-circuit member 13 to excite a high-frequency resonant mode of the antenna system.

In this embodiment, the feeder member 11 has a long straight-line shape with a length of about 30 mm and a width of about 3 mm. The radiation conductor 12 has a rectangular shape with a length of about 60 mm and a width of about 3 mm. The short-circuit member 13 has a parallelogram shape with a length of about 68 mm, an upper side of about 5 mm, a lower side of about 5 mm, and a height of about 42 mm. In this embodiment, the coupling unit 111 is formed by the first coupling side 111a of the feeder member 11 and the second coupling side 111b of the short-circuit member 13. However, a chip capacitor may also be used to realize the capacitive coupling transmission effect in the present invention.

Refer to FIG. 2 a top view of a multiband antenna according to a second embodiment of the present invention. The second embodiment is basically similar to the first embodiment except the feeder member 11 and the short-circuit member 13 have a stepped shape. In the second embodiment, the first coupling side 111a of the feeder member 11 is also parallel to the second coupling side 111b of the short-circuit member 13. Thus are generated the standard frequency bands of the high-frequency and low-frequency systems of the antenna system.

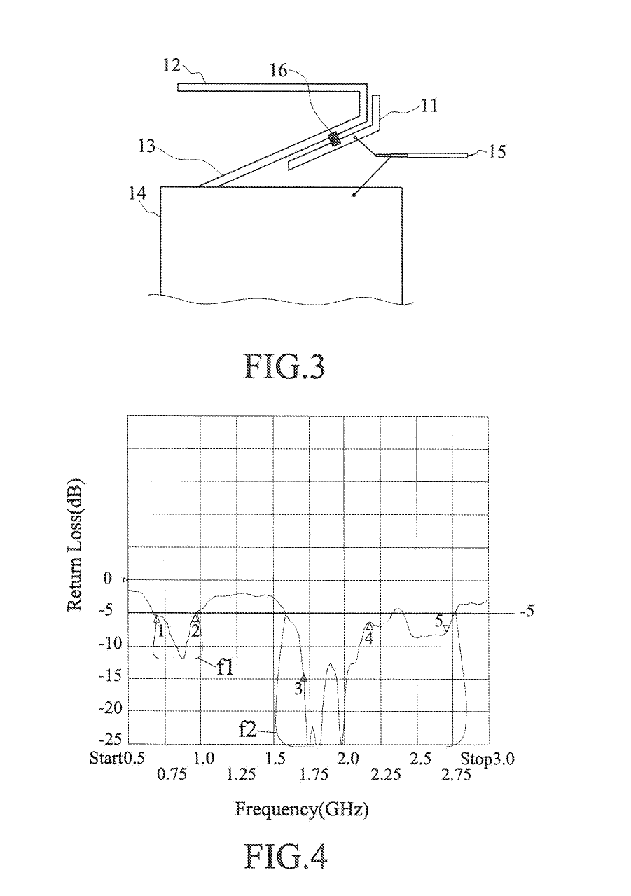

Refer to FIG. 3 a top view of a multiband antenna according to a third embodiment of the present invention. The third embodiment is basically similar to the first embodiment except the coupling unit 111 is not formed by the first coupling side 111a and the second coupling side 111b but is realized by a chip capacitor 16. The chip capacitor 16 functions as a high-frequency signal coupling medium coupling signals from the feeder member 11 to the short-circuit member 13 to achieve a capacitive coupling transmission effect.

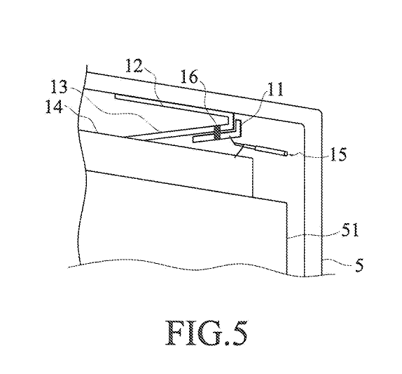

Refer to FIG. 4 a diagram showing the measurement results of the return loss of the multiband antenna of the third embodiment, wherein the abscissa denotes the frequency and the ordinate denotes the dB value. When bandwidths of the antenna system are defined by a return loss of over 5 dB, the operation frequency of bandwidth f1 is between 698 and 960 MHz, which covers the LTE and AMPS systems. The operation frequency of bandwidth f2 is between 1710 and 2700 MHz, which covers the DCS and WCDMA systems. From the measurement results, it is known that the present invention indeed achieves the designed operational frequency bands.

Refer to FIG. 5 a partially-enlarged view schematically showing that the multiband antenna of the third embodiment is integrated with a portable computer. In assemblage, the antenna module is arranged in the edge of a panel 51 of a portable computer 5. As mentioned above, the chip capacitor 16 is arranged between the feeder member 11 and the short-circuit member 13 to replace the first coupling side 111a and the second coupling side 111b. Such a design can also achieve the capacitive coupling transmission effect.

The present invention indeed possesses utility, novelty and non-obviousness and meets the condition for a patent. The embodiments described above are only to exemplify the present invention but not to limit the scope of the present invention. Therefore, any equivalent modification or variation according to the spirit of the present invention is to be also included within the scope of the present invention.

What is claimed is:

1. A multiband antenna comprising
a feeder member having a first coupling side;
a radiation conductor;
a short-circuit member having a second coupling side extending along said first coupling side and conformable to a shape of said first coupling side, wherein one end of said short-circuit member is connected with said radiation conductor, and wherein a gap exists between said first coupling side and said second coupling side;
a grounding plane connected with another end of said short-circuit member; and
a feeder cable including
a central wire connected with said feeder member; and
an outer wire connected with said grounding plane.

2. The multiband antenna according to claim 1, wherein a lateral side of said radiation conductor is parallel to a lateral side of said grounding plane.

3. The multiband antenna according to claim 1, wherein said first coupling side of said feeder member is parallel to said second coupling side of said short-circuit member.

4. The multiband antenna according to claim 1, wherein said first coupling side of said feeder member and said second coupling side of said short-circuit member form a coupling unit.

5. The multiband antenna according to claim 4, wherein a chip capacitor is installed in said coupling unit.

6. The multiband antenna according to claim 1, wherein said short-circuit member has a straight-line shape or a stepped shape.
